(19) United States
(12) Patent Application Publication
(10) Pub. No.: US 2025/0349108 A1
(43) Pub. Date: Nov. 13, 2025

(54) IMAGE PROCESSING METHOD, IMAGE PROCESSING APPARATUS, IMAGE PROCESSING SYSTEM, AND STORAGE MEDIUM

(71) Applicant: CANON KABUSHIKI KAISHA, Tokyo (JP)

(72) Inventors: YUICHI KUSUMI, Tochigi (JP); YOSHIAKI IDA, Saitama (JP); YUKINO ONO, Tochigi (JP)

(21) Appl. No.: 19/199,190

(22) Filed: May 5, 2025

(30) Foreign Application Priority Data
May 10, 2024 (JP) 2024-077396

(51) Int. Cl. G06V 10/771; G06T 3/40

(52) U.S. Cl. CPC G06V 10/771; G06T 3/40

(57) ABSTRACT

An image processing method includes acquiring first and second input frame groups from a moving image, first and second output frame groups through a machine learning model, and an output moving image frame based on the first and second output frames. Each of the first and second input frames includes first and second frames. A time of each first frame included in one of the first and second input frames is different from any of times included in the other of the first and second input frames. A time of each second frame included in the one of the first and second input frames overlaps a time of one second frame included in the other of the first and second input frames.

### BACKGROUND

### Technical Field

The present disclosure relates to an image processing method, an image processing apparatus, an image processing system, and a storage medium.

### Description of Related Art

The conventional machine learning model can be used to achieve a recognition or regression task for an image with high accuracy. The machine learning model can be used not only for still images but also for moving images having a plurality of frames. In a moving image, in acquiring an output frame, information on frames at the times before and after the time of the output frame can be utilized, so that even more accurate processing is available. US Patent Application Publication No. 2023/019679 discloses a processing method for upscaling an input frame using a machine learning model that propagates feature maps of input frames at the times before and after the time of each output frame.

### SUMMARY

One aspect of the present disclosure provides an image processing method that includes acquiring, from a moving image, a first input frame group including a plurality of consecutive first input frames, acquiring a first output frame group including a plurality of first output frames, the first output frame group being output by a machine learning model that has received and processed the first input frame group, acquiring, from the moving image, a second input frame group including a plurality of consecutive second input frames, acquiring a second output frame group including a plurality of second output frames, the first output frame group being output by the machine learning model that has received and processed the by inputting the second input frame group, and acquiring an output moving image frame based on the plurality of first output frames and the plurality of second output frames. Each of the plurality of first input frames and the plurality of second input frames includes one or more first frames and one or more second frames, a time of each first frame included in one of the plurality of first input frames and the plurality of second input frames being different from any of times included in the other of the plurality of first input frames and the plurality of second input frames, and a time of each second frame included in the one of the plurality of first input frames and the plurality of second input frames overlapping a time of one second frame included in the other of the plurality of first input frames and the plurality of second input frames. An image processing system and an image processing apparatus each utilizing the above image processing method also constitute another aspect of the disclosure.

Further features of various embodiments of the disclosure will become apparent from the following description of embodiments with reference to the attached drawings.

### BRIEF DESCRIPTION OF THE DRAWINGS

FIG. 1 is a block diagram of an image processing system according to a first embodiment.

FIG. 2 is an external view of the image processing system according to the first embodiment.

FIG. 3 illustrates a training flow according to the first embodiment.

FIG. 4 illustrates the training flow of a neural network according to the first embodiment.

FIG. 5 illustrates the training flow of the neural network according to the first embodiment.

FIG. 6 illustrates the training flow of the neural network according to the first embodiment.

FIG. 7 illustrates an example of acquiring an upscaled moving image in the first embodiment.

FIG. 8 is a flowchart illustrating the generation of an upscaled moving image in the first embodiment.

FIG. 9 illustrates an example of a first input frame group and a second input frame group in the first embodiment.

FIG. 10 illustrates an example of acquiring an output moving image frame in the first embodiment.

FIG. 11 is a block diagram of an image processing system according to a second embodiment.

FIG. 12 is an external view of the image processing system according to the second embodiment.

FIG. 13 is a flowchart illustrating the generation of an upscaled moving image in the second embodiment.

FIG. 14 illustrates an example of acquiring an output moving image frame in the second embodiment.

FIG. 15 is a block diagram of an image processing system according to a third embodiment.

FIG. 16 is a flowchart illustrating the generation of an upscaled moving image according to the third embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure. Corresponding elements in respective figures will be designated by the same reference numerals, and a duplicate description thereof will be omitted.

First, an overview of each embodiment will be described. Each embodiment generates an upscaled moving image having a plurality of output frames that have been upscaled, from a moving image having a plurality of consecutive input frames using a machine learning model.

Machine learning models include, for example, neural networks, genetic programming, and Bayesian networks. Neural networks include a convolutional neural network (CNN), a generative adversarial network (GAN), and a recurrent neural network (RNN).

Upscaling is image enlargement processing that generates a sharp, high-resolution image with a large number of pixels by estimating high-frequency components that cannot be expressed in a low-resolution image with a small number of pixels.

Although upscaling has been given as an example, image processing according to each of the following embodiments is also applicable to image processing such as sharpening and noise reduction.

Each embodiment can provide a moving image that has been processed with high quality while suppressing the influence of output frames with reduced image quality due to the inability to fully use information about the previous (or last) and subsequent (or next) frames.

In the following description, a stage in which the weights of the machine learning model are learned (or trained) will be referred to as a training (learning) phase, and a stage in which upscaling is performed using the machine learning model and the trained weights will be referred to as an estimation phase.

An image processing apparatus according to each embodiment may be any apparatus as long as it has an image processing function of the present disclosure, and may be achieved in the form of an image pickup apparatus (e.g. camera) or a PC.

### First Embodiment

This embodiment will discuss a method of upscaling a captured image using a machine learning model.

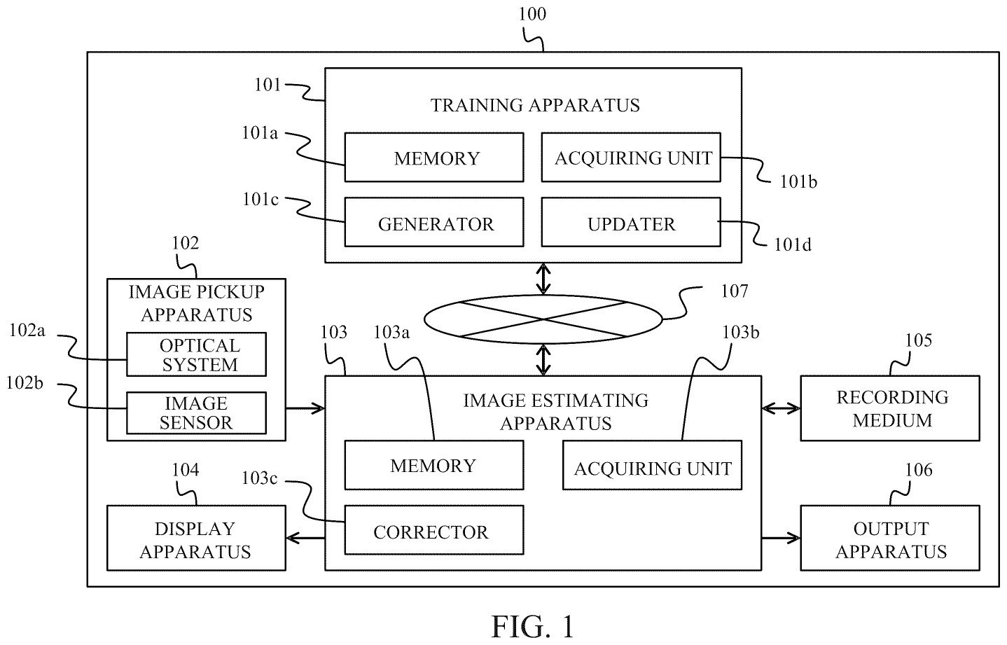

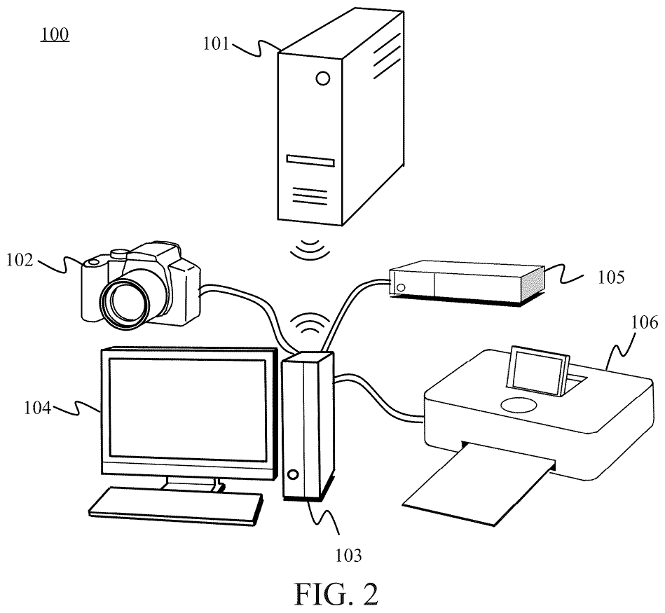

FIG. 1 is a block diagram of an image processing system 100 according to this embodiment. FIG. 2 is an external view of the image processing system 100. The image processing system 100 includes a training (learning) apparatus 101, an image pickup apparatus 102, an image estimating apparatus (image processing apparatus) 103, a display apparatus 104, a recording medium 105, an output apparatus 106, and a network 107.

The training apparatus 101 is an image processing apparatus that executes training processing, and includes a memory 101a, an acquiring unit 101b, a generator 101c, and an updater 101d. The acquiring unit 101b acquires a series of training images and a series of corresponding ground truth images. The generator 101c inputs training images into a multilayer neural network to generate a series of output images. The updater 101d updates the network parameters of the neural network based on the errors between the output images and the ground truth images calculated by the generator 101c. Details of the training processing will be described later using a flowchart. The trained network parameters are stored in the memory 101a.

The image pickup apparatus 102 includes an optical system 102a and an image sensor 102b. The optical system 102a condenses light incident on the image pickup apparatus 102 from object space. The image sensor 102b receives (photoelectrically converts) an optical image (object image) formed through the optical system 102a to obtain a captured image. The image sensor 102b is, for example, a charge coupled device (CCD) sensor or a complementary metal-oxide semiconductor (CMOS) sensor. The captured image and the captured moving image acquired by the image pickup apparatus 102 contain blurs due to aberration and diffraction of the optical system 102a and noises due to the image sensor 102b.

The image estimating apparatus 103 is an apparatus that executes the estimation processing, and includes a memory 103a, an acquiring unit 103b, and a corrector 103c. The image estimating apparatus 103 may include at least one processor that executes instructions. The image estimating apparatus 103 performs upscaling processing for the captured moving image including the plurality of captured images acquired to generate an output moving image. A multilayer neural network is used for the upscaling, and the network parameter information is read from the memory 103a. The network parameters are trained by the training apparatus 101, and the image estimating apparatus 103 previously reads the network parameters from the memory 101a via the network 107 and stores them in the memory 103a. The stored network parameters may be in the form of numerical values themselves or in an encoded format. Details regarding training of the network parameters and upscaling using the network parameters will be described later.

The output moving image is output to at least one of the display apparatus 104, the recording medium 105, and the output apparatus 106. The display apparatus 104 is, for example, a liquid crystal display or a projector. A user can perform editing work etc. while checking the moving image in the middle of processing via the display apparatus 104. The recording medium 105 is, for example, a semiconductor memory, a hard disk drive, or a server on the network. The output apparatus 106 is, for example, a printer. The image estimating apparatus 103 has a function of performing development processing and other image processing, as necessary.

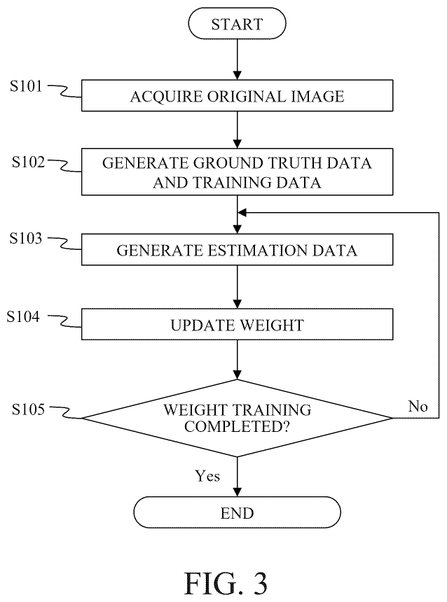

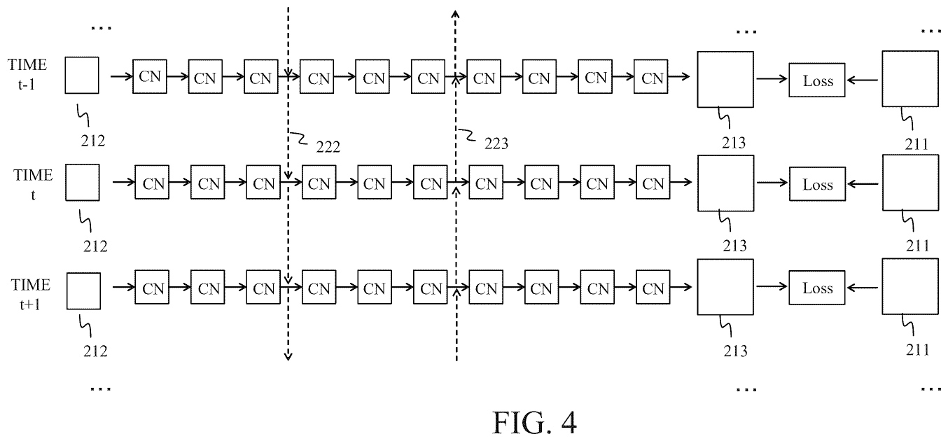

Referring now to FIGS. 3 and 4, a description will be given of the weight (weight information) training method (generating method of a trained model) executed by the training apparatus 101 according to this embodiment. FIG. 3 illustrates a flow of training weights. Each step in FIG. 3 is mainly executed by the acquiring unit 101b, the generator 101c, or the updater 101d in the training apparatus 101. FIG. 4 illustrates a flow of training weights of a neural network (machine learning model).

In step S101, the acquiring unit 101b acquires an original moving image including a plurality of original still images (object images). In this embodiment, the original moving image is a moving image including a high-resolution (high-quality) original still image with few blurs due to aberration or diffraction of the optical system 102a. A plurality of original moving images are acquired. The acquired moving images have images including various objects, that is, edges of various strengths and directions, textures, gradations, flat parts, etc. Various motions caused by motions of a viewpoint and an object are included between the plurality of original still images in the original moving image. The original still image and the original moving image may be real-life images or images generated by computer graphics (CG).

The original still image and the original moving image may have a signal value higher than the luminance saturation value of the image sensor 102b. This is because, even in actual objects, some objects can exceed the luminance saturation value when imaging is performed by the image pickup apparatus 102 under specific exposure conditions. The original still image and the original moving image are generated by reducing the original still image and clipping the signal at the luminance saturation value of the image sensor 102b. In particular, in a case where a real image is used as the original still image, blurs have already occurred due to aberration and diffraction, so by reducing the image, the influence of the blurs can be reduced and a high-resolution (high-quality) image can be acquired. In a case where the original still image contains sufficient high-frequency components, reduction is unnecessary. The original still image may also contain noise components. In this case, the noise contained in the original still image can be considered to be the object, so the noise in the original still image is not particularly problematic.

In step S102, the generator 101c generates a ground truth patch (ground truth data) including a plurality of consecutive images and a training patch (training data) including a plurality of consecutive images corresponding to the ground truth patch. A plurality of ground truth patches and training patches are generated, and one or more patches are generated corresponding to one original moving image. In this embodiment, the ground truth patches and training patches are a plurality of consecutive images that reflect the same object. This embodiment uses a plurality of combinations each having a set of the ground truth patch and the training patch as training data. A patch refers to a plurality of images having a predefined number of pixels (e.g., 64×64 pixels, etc.) and a predefined number of frames (e.g., 10 frames, etc.).

This embodiment uses mini-batch training for training the weights for the multi-layered neural network. Thus, in step S102, a plurality of sets of ground truth patches and training patches are generated. However, the present disclosure is not limited to this example, and online training or batch training may be used. In this embodiment, the original still image, the original moving image, the ground truth patches, and the training patches may be undeveloped images (raw images), or may be developed images. However, in training using the raw images, the raw images are also input during estimation, and in training using the developed images, the developed images are also input during estimation.

In step S103, the generator 101c inputs a training patch (training data) 212 including a plurality of consecutive images in FIG. 4 into the multilayered neural network, and generates an estimated patch (estimated data) 213 including a plurality of consecutive images. For mini-batch training, the estimated patch 213 corresponding to the plurality of training patches 212 is generated. FIG. 4 illustrates a flow from step S103 to step S104. The estimated patch 213 has a larger number of pixels (higher sharpness) than that of the training patch 212, and ideally coincides with a ground truth patch (ground truth data) 211. This embodiment uses the neural network configuration illustrated in FIG. 4. CN in FIG. 4 represents a convolution layer, which calculates the convolution of the input and the filter, and the sum with the bias, and nonlinearly transforms the result using the activation function. Initial values of each component of the filter and the bias are arbitrary, and are determined by random numbers in this embodiment. The activation function can be, for example, Rectified Linear Unit (ReLU) or a sigmoid function. Although a convolutional layer is used for the configuration of the neural network, the present disclosure is not limited to this example, and a residual block or the like may be used instead of the convolutional layer.

An output from each layer except the final layer is called a feature map. For each of the plurality of training patches 212, the estimated patch 213 is generated. Propagation from a previous time 222 and propagation from a later time 223 combine feature maps output from intermediate layers at the previous or later time. The feature maps are combined by concatenating them in the channel direction, but addition or weighted addition of each feature map may also be performed. FIG. 4 illustrates propagations at times t−1 and t+1 before and after time t, but this embodiment is not limited to this example, and propagations at even more distant times such as times t−2 and t+2 before and after time t may also be added. The propagation at the later time (t+1) is performed after the propagation at the previous time (t−1) is performed, but this embodiment is not limited to this example, and the propagation at the later time may be performed first, or the propagations at the previous and subsequent times may be performed simultaneously. The propagations at the previous and subsequent times are performed once each, but they may be performed multiple times.

Here, a shift occurs in the feature maps at the previous or later time due to motions of a viewpoint and an object. Therefore, the feature maps may be aligned and combined at the previous or later time. Various alignment methods may be used such as a method using an optical flow and deformable convolution. The alignment using the optical flow may include a separate step of acquiring an optical flow between each time from a plurality of consecutive images in a training patch.

This embodiment has discussed the configuration of the neural network in FIG. 4 as an example, but is not limited to this example, and may apply various variations as long as a training patch having a plurality of consecutive images is input and an estimated patch having a corresponding multiple consecutive images is output. Each image of the estimated patch may be acquired by using information on at least one of the time before and after the time of each image. The information on at least one of the time before and after the time of each image may be the above feature map, a feature map acquired using an input image, or an image (frame). In a case where an image is used as the information on the previous and subsequent times, an image acquired by combining (concatenating or adding in the channel direction) the previous and subsequent images may be input to the convolution layer.

In training the machine learning model that performs upscaling, the size of the output patch and the ground truth patch is changed according to an upscaling factor (magnification). The upscaling factor is the vertical and horizontal factor in a case where an image is enlarged. In a case where the upscaling factor is 2 (twice), the size of the output patch and the ground truth patch is twice the size of the training patch (twice in each of the vertical and horizontal directions, 4 times the number of pixels).

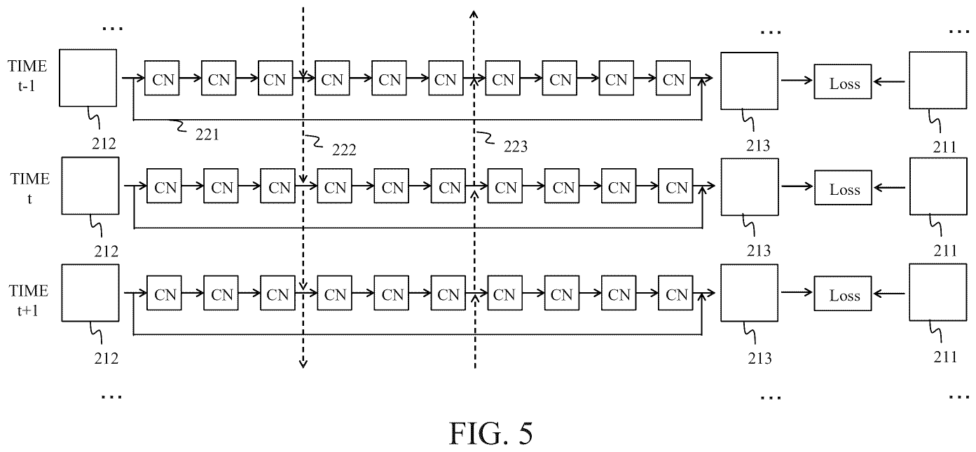

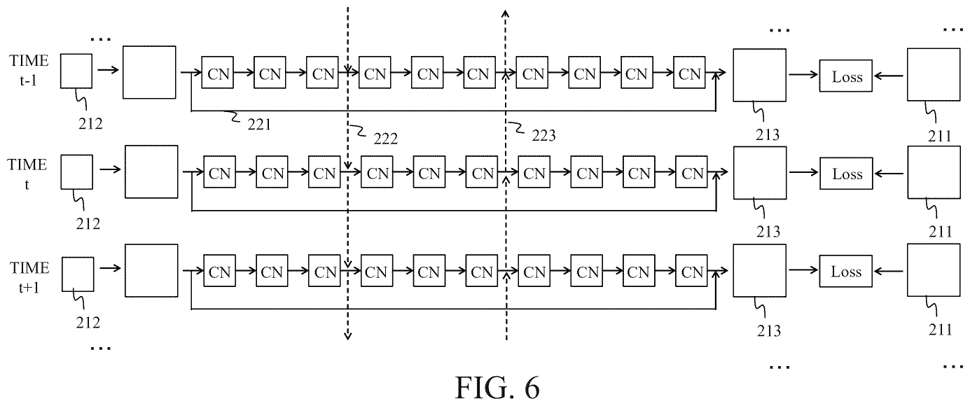

As illustrated in FIG. 5, a neural network may be configured to output an estimated patch of the same size in which the degradation caused by the interpolation processing is corrected, by processing an image acquired by enlarging the training patch by the upscaling factor through interpolation processing, and setting the image as the training patch. A skip connection 221 calculates the sum of the residual estimated from the training patch 212 and the ground truth patch 211 and the training patch 212 to generate the estimated patch 213. In performing the skip connection 221, the combination of the feature maps calculates the sum of elements. As illustrated in FIG. 6, a neural network may be configured to process an image acquired by enlarging the training patch by the upscaling factor through the interpolation processing in a convolutional layer, and output an estimated patch having a size of the upscaling factor of the training patch.

In step S104, the updater 101d updates the weight (weight information) for the neural network based on the error between the estimated patch 213 and the ground truth patch (ground truth data) 211. Here, the weight includes a filter component and bias of each layer. Backpropagation is used to update the weight, but this embodiment is not limited to this example. For mini-batch training, errors between a plurality of ground truth patches 211 and corresponding estimated patches 213 are acquired, and the weights are updated. For a loss function, for example, the L2 norm or the L1 norm may be used.

In step S105, the updater 101d determines whether the training of the weights has been completed. The completion can be determined based on whether the number of iterations of training (updating the weights) has reached a specified value, or whether a weight change amount during updating is smaller than a specified value. In a case where it is determined that the training has not yet been completed, the flow returns to step S102, and a plurality of new ground truth patches and training patches are acquired. In a case where it is determined that the training has been completed, the training apparatus 101 (updater 101d) ends the training, and stores the weight information in the memory 101a.

A description will now be given of the generation of an upscaled moving image (upscaling processing) executed by the image estimating apparatus 103 according to this embodiment.

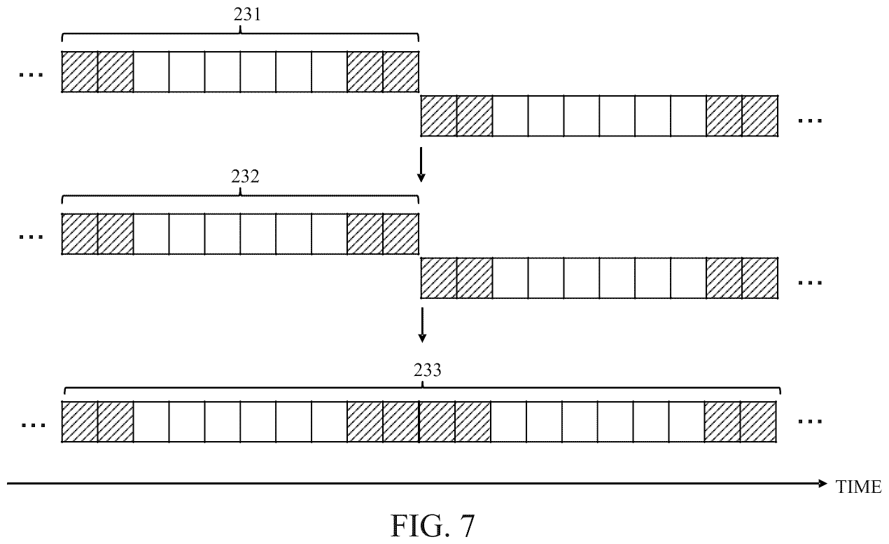

A description will now be given of the effects of the present disclosure before a detailed description of the upscaling processing is discussed. FIG. 7 illustrates an example of performing the upscaling processing for a moving image using a machine learning model to obtain an upscaled moving image. In upscaling a moving image, the upscaling processing is performed for each input frame group 231 having a plurality of input frames that are part of the moving image. By repeating this flow, an output moving image frame 233 (upscaled moving image) including an output frame group 232 having a plurality of upscaled output frames is acquired.

In this embodiment, the input frame group 231 has 10 frames, and in acquiring each output frame in the output frame group 232, information on a total of four times, the previous two times and the next two times, is used. Now pay attention to one output frame group 232. The output frame at the edge of the time where the information on the previous and subsequent times could not be fully used (illustrated by a hatched block) has an image quality lower than that of the other output frame. In a case where an output moving image frame is acquired by concatenating an output frame group including an output frame where the information on the previous and subsequent times could not be fully used, an image quality difference occurs between the frames, and the image quality of the moving image is also reduced. Accordingly, this embodiment performs upscaling processing while parts of frames for each input frame group overlap each other, and constructs an output moving image frame. Thereby, an upscaled moving image is acquired with high image quality while the influence of an output frame with lowered image quality due to the inability to fully use the previous and subsequent frames is suppressed.

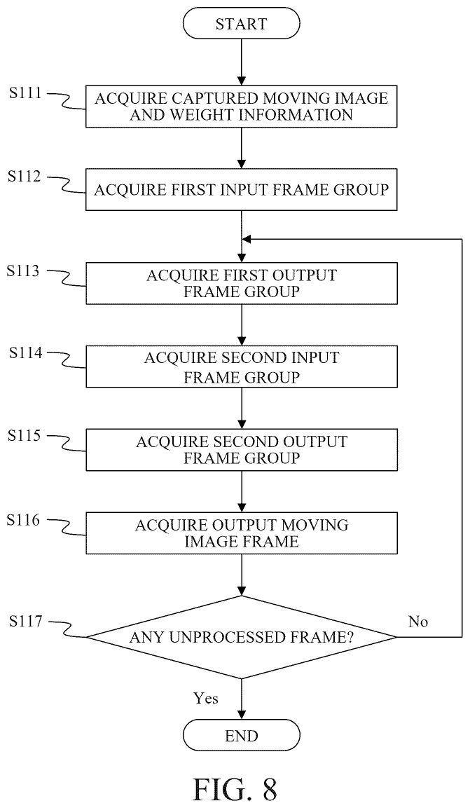

Referring now to FIG. 8, a description will be given of the generation of an upscaled moving image (upscaling processing) executed by the image estimating apparatus 103 according to this embodiment. FIG. 8 is a flowchart illustrating the generation of an upscaled moving image. Each step in FIG. 8 is mainly executed by the acquiring unit 103b and the corrector 103c in the image estimating apparatus 103.

In step S111, the acquiring unit 103b acquires the captured moving image and weight information. The captured moving image is a moving image including an undeveloped raw image or a developed image, similarly to training, and in this embodiment, it is transmitted from the image pickup apparatus 102. The weight information is the weight of the machine learning model transmitted from the training apparatus 101 and stored in the memory 103a.

In step S112, the acquiring unit 103b acquires an input frame group (first input frame group) including a plurality of consecutive input frames from the captured moving image. This embodiment acquires an input frame group including 10 frames.

In step S113, the corrector 103c performs upscaling processing for the first input frame group based on the acquired weight of the machine learning model, and acquires an output frame group (first output frame group) including a plurality of upscaled output frames. This embodiment performs upscaling processing for the input frame group including 10 frames, and acquires an output frame group including 10 upscaled frames.

In step S114, the acquiring unit 103b acquires an input frame group (second input frame group) including a plurality of consecutive frames from the captured moving image. Here, the first input frame group and the second input frame group include at least one frame at different times, and include at least one frame at an overlapping time (so that the times overlap each other).

Here, the number of frames at the overlapping time between the first input frame group and the second input frame group is set to be equal to or greater than the number of previous or subsequent times that are used in acquiring each output frame in the machine learning model. The number of overlapping times between the first input frame group and the second input frame group may be twice or more than twice as large as the number of previous or subsequent times that are used in acquiring each output frame in the machine learning model. In acquiring an output frame, this embodiment uses information on a total of four times, two previous times and two subsequent times, and the number of overlapping times is four times, which is twice as large as the number of previous or subsequent two times. Due to this configuration, the subsequent steps can provide an output moving image frame with only from high-quality output frames acquired by fully using the previous and subsequent frames.

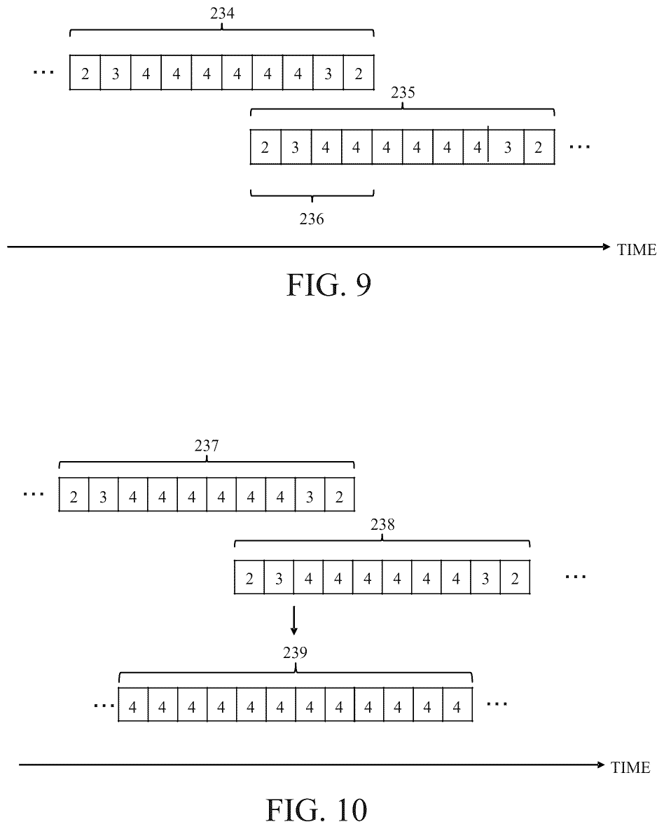

FIG. 9 illustrates an example of the first input frame group and the second input frame group. This embodiment illustrates an example in which a first input frame group 234 and a second input frame group 235 have 10 frames, and overlapping frames 236 are four frames. In FIG. 9, a numerical value written in each block corresponding to each input frame in each input frame group indicates the number of previous and subsequent times used in acquiring each corresponding output frame. In acquiring an output frame, this embodiment uses information on a total of four times, two previous times and two subsequent times, so that the most accurate output frame can be acquired at a time in a case where information on four times can be used. The output frames corresponding to the first two frames and the last two frames in the first input frame group 234 and the second input frame group 235 cannot fully use the information on the previous and subsequent times compared to other times, so that the image quality is lower than that of the output frames at other times.

In step S115, the corrector 103c performs upscaling processing based on the weight of the machine learning model acquired in step S111, and acquires an output frame group (second output frame group) including a plurality of upscaled output frames.

In step S116, the corrector 103c concatenates the first input frame group and the second input frame group and acquires an output moving image frame. As described above, the first input frame group and the second input frame group include frames with overlapping times. Therefore, for each output frame corresponding to a frame at the overlapping time, the output frame at the overlapping time is excluded from one of the first and second output frame groups and concatenated to acquire an output moving image frame. Here, in the output frames corresponding to the overlapping times in the first input frame group and the second input frame group, output frames with a smaller number of previous and subsequent times used in acquiring each output frame are excluded.

FIG. 10 illustrates an example of acquiring an output moving image frame 239 from a first output frame group 237 and a second output frame group 238. In FIG. 10 as well, a numerical value in each block corresponding to each output frame in each output frame group indicates the number of previous and subsequent times that are used in acquiring each output frame. In this embodiment, in order to exclude output frames with the smaller number of previous and subsequent times that are used in acquiring each output frame from among the output frames at the overlapping times, output frames having two and three for the number of previous and subsequent times are excluded and concatenated to obtain the output moving image frame 239. Thereby, an output moving image frame can be configured that has been processed with high quality without using output frames with reduced image quality due to the inability to fully use the information of the previous and subsequent times.

This embodiment excludes output frames at the overlapping times from the first and second output frame groups, but can output an output frame group in which output frames with the overlapping times are excluded in the machine learning model.

In step S117, in a case where there are unprocessed frames among the frames of the captured moving image or the frames to be processed that are part of the captured moving image, the flow returns to step 114, and the subsequent unprocessed input frame group is acquired and upscaled. In this case, the output moving image frame acquired in step S116 is set as the first output frame group, the output frame group acquired by newly performing the upscale processing is set as the second output frame group, and the output moving image frame is similarly acquired by concatenation in step S116.

In step S117, in a case where there are no unprocessed frames among the frames of the captured moving image or the frames to be processed that are part of the captured moving image, the flow ends and an output moving image frame is acquired as an output moving image (upscaled moving image).

The above processing can provide an upscaled moving image that has been processed with high quality while suppressing the influence of an output frame in which image quality has been reduced because information about the previous and subsequent times cannot be fully used.

### SECOND EMBODIMENT

This embodiment will discuss a configuration in which the generation of an upscaled moving image is executed by an image estimator in an image pickup apparatus. This embodiment is different from the first embodiment in a generation flow of an upscaled moving image. This embodiment acquires an output moving image frame by calculating a weighted average of output frames at overlapping times in each output frame group. This embodiment will discuss only the configuration that is different from that of the first embodiment, and will omit a description of the similar configuration.

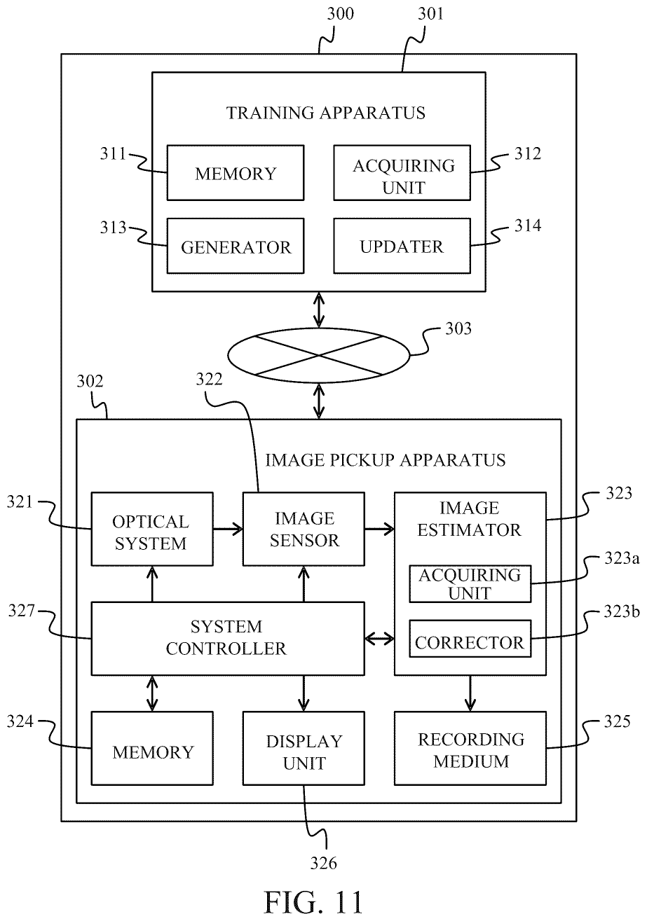

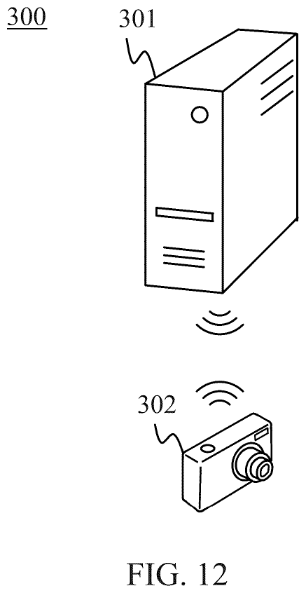

FIG. 11 is a block diagram of an image processing system 300 according to this embodiment. FIG. 12 is an external view of the image processing system 300. The image processing system 300 includes a training apparatus (image processing apparatus) 301 and an image pickup apparatus 302 connected via a network 303.

The training apparatus 301 includes a memory 311, an acquiring unit 312, a generator 313, and an updater (training unit) 314, and trains weights (weight information) for upscaling using the neural network.

The image pickup apparatus 302 images the object space, acquires a captured moving image, and generates an upscaled moving image from the captured moving image using the read weight information. The image pickup apparatus 302 includes an optical system 321 and an image sensor 322. The image estimator 323 has an acquiring unit 323a and a corrector 323b, and performs upscaling processing for the captured moving image using the weight information stored in the memory 324.

The weight information has already been trained by the training apparatus 301 and stored in the memory 311. The image pickup apparatus 302 reads out the weight information from the memory 311 via the network 303 and stores it in the memory 324. The captured moving image and the upscaled moving image are stored in a recording medium 325. In a case where an instruction to display the upscaled moving image is issued by the user, the stored upscaled moving image is read out and displayed on the display unit 326. The captured moving image already stored in the recording medium 325 may be read out and upscaled by the image estimator 323. The above series of controls are performed by the system controller 327.

The training method of the machine learning model executed by the training apparatus 301 according to this embodiment is similar to that in the first embodiment, and thus a description thereof will be omitted.

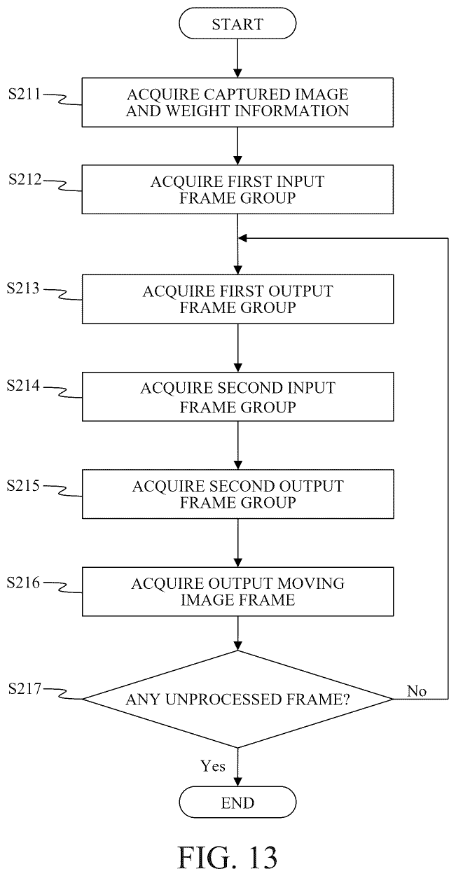

Referring now to FIG. 13, a description will be given of upscaling processing of the moving image executed by the image estimator 323 according to this embodiment. FIG. 13 is a flowchart illustrating the generation of an upscaled moving image. The steps of FIG. 13 are mainly executed by the acquiring unit 323a and the corrector 323b in the image estimator 323. The steps other than step S216 are similar to the steps other than step S216 executed by the acquiring unit 103b and the corrector 103c in the first embodiment, and thus a description thereof will be omitted.

In step S216, the corrector 323b concatenates the upscaled first output frame group and the second output frame group, and acquires an output moving image frame. As described in the first embodiment, since the first input frame group and the second input frame group include frames at overlapping times, the output moving image frame is acquired by concatenating the output frames at the overlapping times with a weighted average. Here, at the overlapping times between the first input frame group and the second input frame group, the weighted average may be performed by reducing the weight of the output frame that has a small amount of information on the previous or later time used in acquiring each output frame.

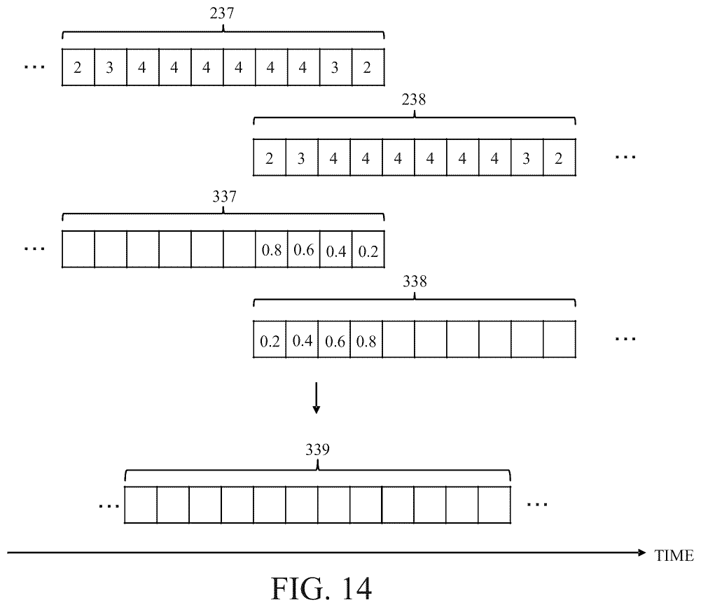

FIG. 14 illustrates an example of acquiring an output moving image frame 339 from the first output frame group 237 and the second output frame group 238. This embodiment performs the weighted average by reducing a weight for an output frame that has a smaller number of pieces of information on the previous or subsequent time that has been used in acquiring each output frame among the output frames at the overlapping times. For example, the weights for the first output frame group 237 are as illustrated by a reference numeral 337, and the weights for the second output frame group 238 are as illustrated by a reference numeral 338, and the output frames at overlapping times are weighted, averaged, and concatenated to acquire an output moving image frame 339.

Here, the weight for the weighted average may be determined based on the number of previous and subsequent times that have been used in acquiring each output frame. In FIG. 14 as well, a numerical value written in the block corresponding to each output frame of each output frame group indicates the number of previous and subsequent times that have been used in acquiring each output frame. For example, as illustrated in FIG. 14, in a case where the number of pieces of information on the previous and subsequent times is 2, the weight is set to 0.2, and in a case where the number of pieces of information on the previous and subsequent times is 3, the weight is set to 0.4. However, this embodiment is not limited to this example. Thereby, a high-quality upscaled moving image can be acquired while the influence of an output frame with reduced image quality due to the inability to fully use the previous and subsequent frames is suppressed.

### Third Embodiment

An image processing system according to this embodiment is different from that of each of the first and second embodiments in that it has a processing apparatus (computer) configured to transmit a captured moving image, which is a target of image processing, to the image estimating apparatus, and to receive a processed output image (upscaled image) from the image estimating apparatus. This embodiment will discuss only the configuration different from that of the first embodiment, and will omit a description of a similar configuration.

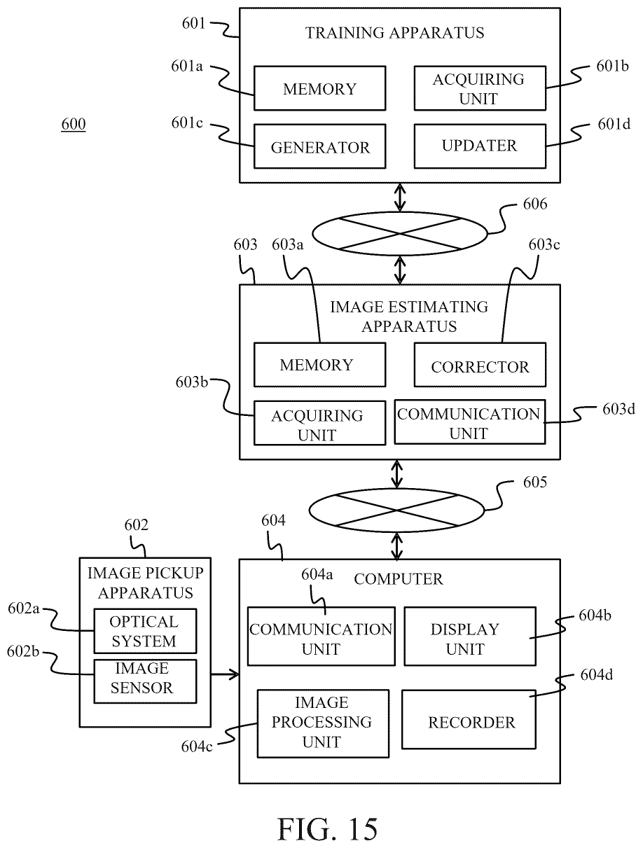

FIG. 15 is a block diagram of an image processing system 600 according to this embodiment. The image processing system 600 includes a training apparatus 601, an image pickup apparatus 602, an image estimating apparatus 603, and a computer (processing apparatus) 604. The training apparatus 601 and the image estimating apparatus 603 are, for example, servers. The computer 604 is, for example, a user terminal (personal computer or smartphone). The computer 604 is connected to the image estimating apparatus 603 via a network 605. The image estimating apparatus 603 is connected to the training apparatus 601 via a network 606. That is, the computer 604 and the image estimating apparatus 603 are communicable with each other, and the image estimating apparatus 603 and the training apparatus 601 are communicable with each other.

The configuration of the training apparatus 601 is similar to that of the training apparatus 101 according to the first embodiment, and thus a description thereof will be omitted. The configuration of the image pickup apparatus 602 is similar to that of the image pickup apparatus 102 according to the first embodiment, and thus a description thereof will be omitted.

The image estimating apparatus 603 includes a memory 603a, an acquiring unit 603b, a corrector 603c, and a communication unit (receiver) 603d. The memory 603a, the acquiring unit 603b, and the corrector 603c are respectively similar to the memory 103a, the acquiring unit 103b, and the corrector 103c of the image estimating apparatus 103 according to the first embodiment. The communication unit 603d has a function of receiving a request transmitted from the computer 604, and a function of transmitting an output moving image generated by the image estimating apparatus 603 to the computer 604.

The computer 604 includes a communication unit (transmitter) 604a, a display unit 604b, an image processing unit 604c, and a recorder 604d. The communication unit 604a has a function of transmitting a request to the image estimating apparatus 603 to cause the image estimating apparatus 603 to execute processing for the captured moving image, and a function of receiving an output image processed by the image estimating apparatus 603. The display unit 604b has a function of displaying various information. Information displayed by the display unit 604b includes, for example, a captured moving image to be transmitted to the image estimating apparatus 603 and an output moving image received from the image estimating apparatus 603. The image processing unit 604c has a function of performing further image processing for the output moving image received from the image estimating apparatus 603. The recorder 604d records the captured moving image acquired from the image pickup apparatus 602, the output moving image received from the image estimating apparatus 603, and the like.

The image processing according to this embodiment will be described below. The image processing according to this embodiment is equivalent to the upscaling processing of the moving image (FIG. 8) described in the first embodiment.

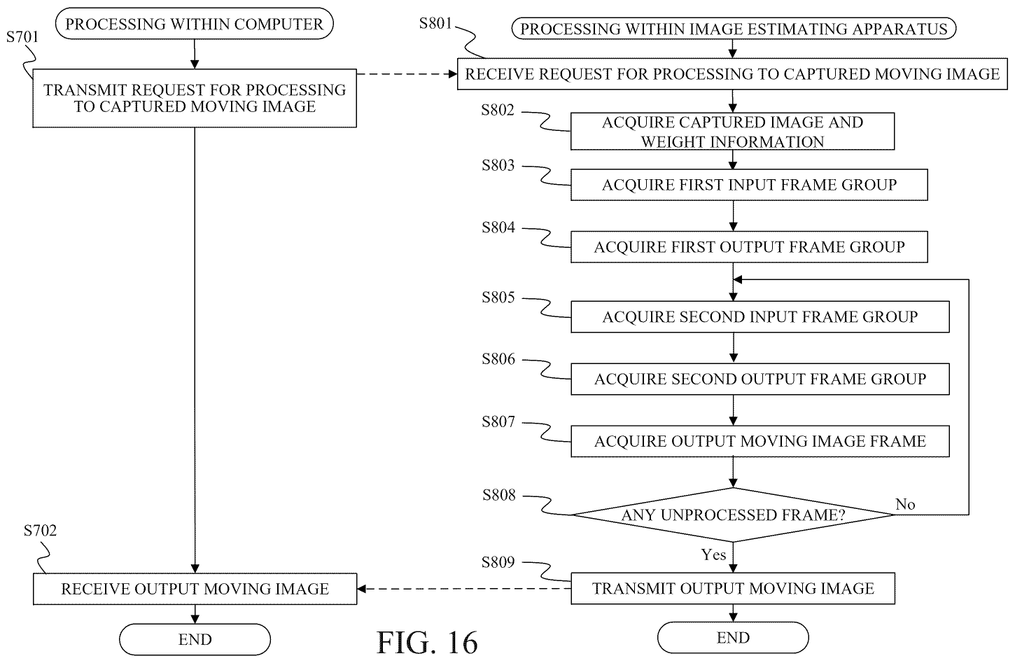

FIG. 16 is a flowchart illustrating the generation of an upscaled moving image in this embodiment. The flow in FIG. 16 is started in a case where a user issues an instruction to start image processing via computer 604. A description will now be given of the operation of the computer 604.

In step S701, the computer 604 transmits a request for processing the captured moving image to the image estimating apparatus 603. Any method may be used to transmit the captured moving image to be processed to the image estimating apparatus 603. For example, the captured moving image may be uploaded to the image estimating apparatus 603 simultaneously with the processing of step S701, or may be uploaded to the image estimating apparatus 603 prior to the processing of step S701. The captured moving image may be an image stored on a server different from image estimating apparatus 603. In step S701, the computer 604 may transmit ID information etc. for authenticating a user together with a request for processing a captured moving image.

In step S702, the computer 604 receives an output moving image generated within the image estimating apparatus 603. The output image is an upscaled moving image, as in the first embodiment.

A description will now be given of the operation of the image estimating apparatus 603.

In step S801, the image estimating apparatus 603 receives a request for processing a captured moving image transmitted from the computer 604. The image estimating apparatus 603 determines that upscaling processing for the captured moving image has been instructed, and executes the processing of step S802 and the subsequent steps.

In step S802, the image estimating apparatus 603 acquires the captured moving image and weight information. The weight information is information (trained or learned model) trained in a manner similar to that (FIG. 3) in the first embodiment. The image estimating apparatus 603 may acquire the weight information from the training apparatus 601, or may acquire weight information previously acquired from the training apparatus 601 and stored in the memory 603a.

The processing from step S802 to step S808 is similar to the processing from step S111 to step S117 in the first embodiment, respectively, and thus a description thereof will be omitted.

In step S809, the image estimating apparatus 603 transmits the output moving image to the computer 604.

This embodiment performs the upscaling processing according to the first embodiment, but may perform the upscaling processing according to the second embodiment. This embodiment may implement similar processing and acquire the effects regarding tasks other than the upscaling processing.

In a case where the correction processing is performed within the image estimating apparatus 603 as in this embodiment, the processing load due to the upscaling processing can be borne within the image estimating apparatus 603, so that the processing capacity required for the computer 604 can be reduced.

As described above, as in this embodiment, the image estimating apparatus 603 may be configured controllable using the computer 604 connected communicably to the image estimating apparatus 603.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide an image processing method that can acquire a moving image that has been processed with high quality.

This application claims priority to Japanese Patent Application No. 2024-077396, which was filed on May 10, 2024, and which is hereby incorporated by reference herein in its entirety.

What is claimed is:

1. An image processing method comprising:
acquiring, from a moving image, a first input frame group including a plurality of consecutive first input frames;
acquiring a first output frame group including a plurality of first output frames, the first output frame group being output by a machine learning model that has received and processed the first input frame group;
acquiring, from the moving image, a second input frame group including a plurality of consecutive second input frames;
acquiring a second output frame group including a plurality of second output frames, the first output frame group being output by the machine learning model that has received and processed the by inputting the second input frame group; and
acquiring an output moving image frame based on the plurality of first output frames and the plurality of second output frames,
wherein each of the plurality of first input frames and the plurality of second input frames includes one or more first frames and one or more second frames, a time of each first frame included in one of the plurality of first input frames and the plurality of second input frames being different from any of times included in the other of the plurality of first input frames and the plurality of second input frames, and a time of each second frame included in the one of the plurality of first input frames and the plurality of second input frames overlapping a time of one second frame included in the other of the plurality of first input frames and the plurality of second input frames.

2. The image processing method according to claim 1, wherein the machine learning model uses information on at least one of times before and after a time of each output frame in acquiring the first output frame groups.

3. The image processing method according to claim 2, wherein the machine learning model upscales the first input frame groups and outputs the first output frame groups.

4. The image processing method according to claim 1, wherein the number of second frames included in each of the plurality of first input frames and the plurality of second input frames is equal to or greater than the number of pieces of information at a time before or after a time of each output frame that is used in acquiring each output frame in the machine learning model.

5. The image processing method according to claim 1, wherein the number of second frames included in each of the plurality of first input frames and the plurality of second input frames is twice or more than twice as large as the number of pieces of information at a time before or after a time of each output frame that is used in acquiring each output frame in the machine learning model.

6. The image processing method according to claim 1, wherein the output moving image frame is acquired by using a plurality of output frames from which an output frame corresponding to each second frame is excluded from one of the plurality of first output frames and the plurality of second output frames.

7. The image processing method according to claim 6, wherein the output frame corresponding to each second frame to be excluded is an output frame having a smaller number of pieces of information of at least one of a time before and after a time of each output frame that is used in acquiring each output frame.

8. The image processing method according to claim 1, wherein the output moving image frame is acquired based on an output frame acquired by performing weighted averaging for each second frame included in the plurality of first output frames and each second frame included in the plurality of second output frames.

9. The image processing method according to claim 8, wherein a weight for the weighted averaging is smaller and is assigned to an output frame having a smaller number of pieces of information at at least one of times before and times after a time of each output frame that is used in acquiring each output frame.

10. The image processing method according to claim 1, wherein the machine learning model uses a feature map at at least one of times before and after a time of an output frame in acquiring the output frame.

11. The image processing method according to claim 1, wherein the machine learning model uses a feature map acquired by using an input image at at least one of times before and after a time of an output frame in acquiring the output frame.

12. An image processing apparatus comprising:
at least one memory storing instructions; and
at least one processor that, upon execution of instructions, is configured to:
acquire, from a moving image, a first input frame group including a plurality of consecutive, first input frames,
acquire a first output frame group including a plurality of first output frames, the first output frame group being output by a machine learning model that has received and processed the first input frame group,
acquire, from the moving image, a second input frame group including a plurality of consecutive second input frames,
acquire a second output frame group including a plurality of second output frames, the first output frame group being output by the machine learning model that has received and processed the by inputting the second input frame group, and
acquire an output moving image frame based on the plurality of first output frames and the plurality of second output frames,
wherein each of the plurality of first input frames and the plurality of second input frames includes one or more first frames and one or more second frames, a time of each first frame included in one of the plurality of first input frames and the plurality of second input frames being different from any of times included in the other of the plurality of first input frames and the plurality of second input frames, and a time of each second frame included in the one of the plurality of first input frames and the plurality of second input frames overlapping a time of one second frame included in the other of the plurality of first input frames and the plurality of second input frames.

13. An image processing system comprising:
a first apparatus; and
a second apparatus in communication with the first apparatus,
wherein the first apparatus includes a transmitter configured to transmit a request for executing processing to a moving image to the second apparatus,
wherein the second apparatus includes at least one memory storeing instructions and at least one processor that, upon execution of instructions, is configured to:
receive the request,
acquire a moving image,
acquire, from a moving image, a first input frame group including a plurality of consecutive, first input frames,
acquire a first output frame group including a plurality of first output frames, the first output frame group being output by a machine learning model that has received and processed the first input frame group,
acquire, from the moving image, a second input frame group including a plurality of consecutive second input frames,
acquire a second output frame group including a plurality of second output frames, the first output frame group being output by the machine learning model that has received and processed the by inputting the second input frame group, and
acquire an output moving image frame based on the plurality of first output frames and the plurality of second output frames,
wherein each of the plurality of first input frames and the plurality of second input frames includes one or more first frames and one or more second frames, a time of each first frame included in one of the plurality of first input frames and the plurality of second input frames being different from any of times included in the other of the plurality of first input frames and the plurality of second input frames, and a time of each second frame included in the one of the plurality of first input frames and the plurality of second input frames overlapping a time of one second frame included in the other of the plurality of first input frames and the plurality of second input frames.

14. A non-transitory computer-readable storage medium storing a program that causes a computer to execute an image processing method,
wherein the image processing method includes:
acquiring, from a moving image, a first input frame group including a plurality of consecutive first input frames;
acquiring a first output frame group including a plurality of first output frames, the first output frame group being output by a machine learning model that has received and processed the first input frame group;
acquiring, from the moving image, a second input frame group including a plurality of consecutive second input frames;
acquiring a second output frame group including a plurality of second output frames, the first output frame group being output by the machine learning model that has received and processed the by inputting the second input frame group; and
acquiring an output moving image frame based on the plurality of the first output frames and the plurality of second output frames,
wherein each of the plurality of first input frames and the plurality of second input frames includes one or more first frames and one or more second frames, a time of each first frame included in one of the plurality of first input frames and the plurality of second input frames being different from any of times included in the other of the plurality of first input frames and the plurality of second input frames, and a time of each second frame included in the one of the plurality of first input frames and the plurality of second input frames overlapping a time of one second frame included in the other of the plurality of first input frames and the plurality of second input frames.
